(19) United States
(12) Patent Application Publication
(10) Pub. No.: US 2006/0127203 A1
(43) Pub. Date: Jun. 15, 2006

(54) Cassette stocker and method of forming the same

(75) Inventors: Yu-Yen Chang, Taipei City (TW); Hung-Wei Chen, Tainan City (TW); Chien-Tien Lin, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/122,133

(22) Filed: May 4, 2005

(30) Foreign Application Priority Data
Dec. 9, 2004 (TW) 93138084

(51) Int. Cl. B65G 65/00

(52) U.S. Cl. 414/277

(57) ABSTRACT

A cassette stocker and method of forming the same. The cassette stocker comprises a housing, at least one operation device, and a transferring device. The housing comprises a plurality of openings. The operation device is disposed corresponding to the openings and storing a cassette. The transferring device is disposed in the housing, retrieving and transferring the cassette stored in the operation device via the openings.

### BACKGROUND

The present invention relates to a cassette stocker and method of forming the same, and more particularly to a cassette stocker with modular operation devices.

A cassette stocker is a stocker, for storing and transferring cassettes. FIG. 1A shows a conventional cassette stocker, which comprises a huge housing 510 and a plurality of operation devices 520 such as substrate exchangers, for storing the cassettes 560. A transferring device, such as a crane 540 on a rail 530, is provided in the housing 510 to retrieve and transfer a cassette 560 in the operation devices 520. As shown in FIG. 1B and FIG. 1C, the crane 540 has a rotating platform to retrieve the cassette 560 from one operation device 520, and transfer the cassette 560 to other operation devices 520. Further, the housing 510 comprises an air cleaner 550, such as a fan filter unit (FFU), to filter air in the housing 510 and reduce pollution therein.

In the conventional cassette stocker, the housing 510 encloses the operation devices 520 and the transferring device. The operation devices 520, however, are fixed in the housing 510, and if one operation device 520 is out of order, operation in the cassette stocker is interrupted to disassemble and repair the operation device 520, which reduces retrieval and transferring efficiency.

Further, the operation devices 520 are fixed in the housing 510 and share a single air cleaner 550 on the housing 510. Thus, the operation devices 520 are operated under the same environment. If pollution (such as dust or particles) occurs in one operation device 520, the other operation devices 520 would be affected by retrieving and transferring of the crane 540, and it is hard to distinguish where the pollution from.

### SUMMARY

Accordingly, embodiments of the present invention disclose a cassette stocker. The cassette stocker comprises a housing, at least one-operation device, and a transferring device. The housing comprises a plurality of openings. The operation device is disposed corresponding to the openings and storing a cassette. The transferring device is disposed in the housing, retrieving and transferring the cassette stored in the operation device via the openings.

Further, another embodiment discloses a method of forming a cassette stocker. A housing with a plurality of openings is provided. A operation device detachably connected to the housing via the openings for storing the cassette is provided. A transferring device movably disposed between the openings is provided in the housing, retrieving and transferring the cassette stored in the operation device.

In the method mentioned above, the operation device is disposed outside of or movably in the housing. The cassette stocker further comprises a plurality of blocking plates disposed corresponding to the openings and movably blocking the openings and a moving device moving the operation device in the housing.

The transferring device comprises a rail and a crane movably disposed on the rail, moving between the openings along the rail.

Additionally, the operation device comprises a first air cleaner to filter air in the cassette. The housing comprises a second air cleaner to filter air in the housing. The first air cleaner and the second air cleaner can be a fan filter unit (FFU). As well, the opening are connected to a peripheral operation device which comprises a transmission device or a production device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic view of a conventional cassette stocker;

FIG. 1B is a schematic view of the conventional cassette stocker in FIG. 1A wherein the crane retrieves the cassette;

FIG. 1C is a schematic view of the conventional cassette stocker in FIG. 1A wherein the crane transfers the cassette;

FIG. 2 is a schematic view of an embodiment of the cassette stocker of the present invention;

FIG. 3A is a schematic view of a further embodiment of the cassette stocker of the present invention; and

FIG. 3B is a schematic view of the cassette stocker in FIG. 3A wherein the operation device 20 is removed.

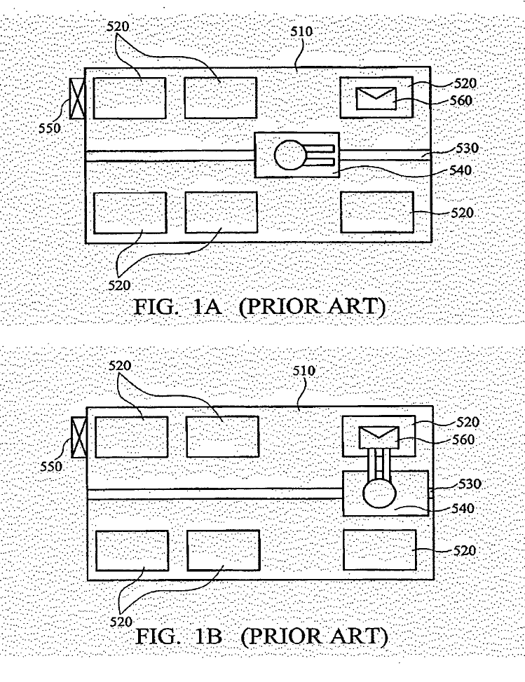

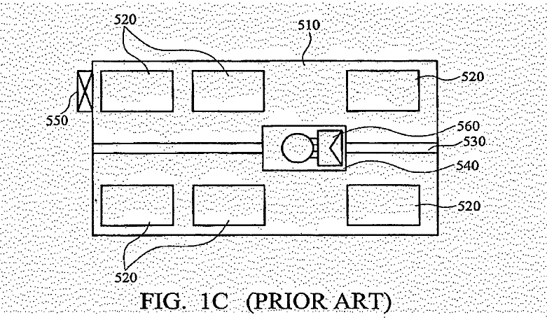

### DETAILED DESCRIPTION

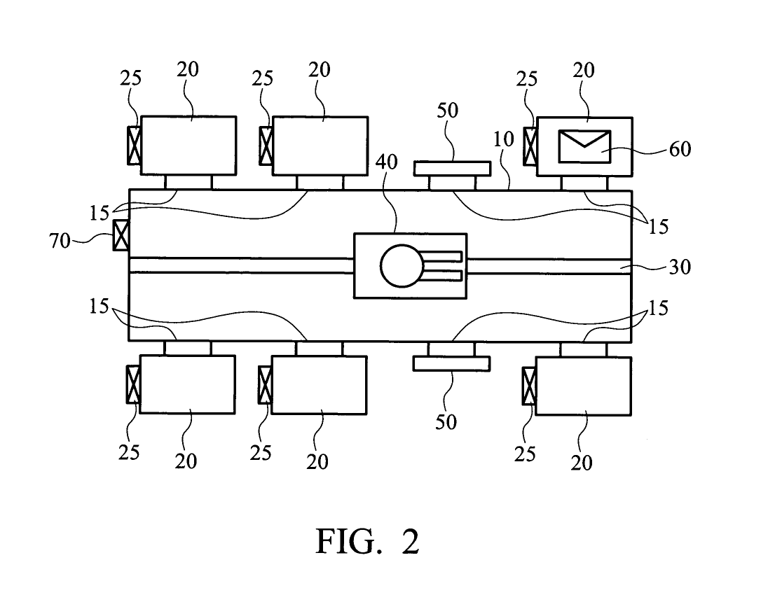

Referencing to FIG. 2, an embodiment of the present invention of a cassette stocker is described hereinafter.

In FIG. 2, the cassette stocker comprises a housing 10, a plurality of operation devices 20 outside of the housing 10, and a transferring device. The operation devices 20 can be pre-stored material exchangers, such as substrate exchangers in the present embodiment. The transferring device comprises a rail 30 and a crane 40 on the rail 30.

In the present embodiment, the operation devices 20 are disposed outside of the housing 10, and the housing 10 has a plurality of openings 15 so that the crane 40 retrieves and transfers the cassette 60 through the openings 15. The operation devices 20 are disposed corresponding to the openings 15 and storing the cassette 60. The cassette 60 stores a plurality of pre-stored materials, such as substrates or flat panels (not illustrated). Each opening 15 without connection to the operation devices 20 has a blocking board 50 to keep the housing 10 in a sealed environment. The crane 40 is disposed movably on the rail 30 and can move between the openings 15 along the rail 30, retrieving and transferring the cassette 60 stored in the operation devices 20. The size of the openings 15 is substantially bigger/equal than the operation devices 20 or substantially bigger than the pre-stored materials.

Further, each operation device 20 has an independent first air cleaner 25, such as a fan filter unit (FFU), to filter air in the operation device 20. The housing 10 also has a second air cleaner 70, such as an FFU, to filter air in the housing 10.

In the present embodiment, only the crane 40 and the rail 30 are disposed in the housing 10. The operation devices 20 are disposed outside of the housing 10. When one operation device 20 is out of order, an opening 15 connected thereto is closed, and the operation device 20 is disassembled and repaired safely without affecting other operation device 20. The operation in the cassette stocker is not interrupted. Thus, retrieval and transferring efficiency is not reduced due to any single operation device 20.

Further, each operation device 20 in the cassette stocker has its own independent first air cleaner 25, and the housing 10 has a second air cleaner 70, which ensures the operation devices 20 to operate under independent environments. If pollution (such as dust or particles) occurs in one operation device 20, the other operation devices 20 would not be affected, and the polluted operation device 20 can be quarantined in time.

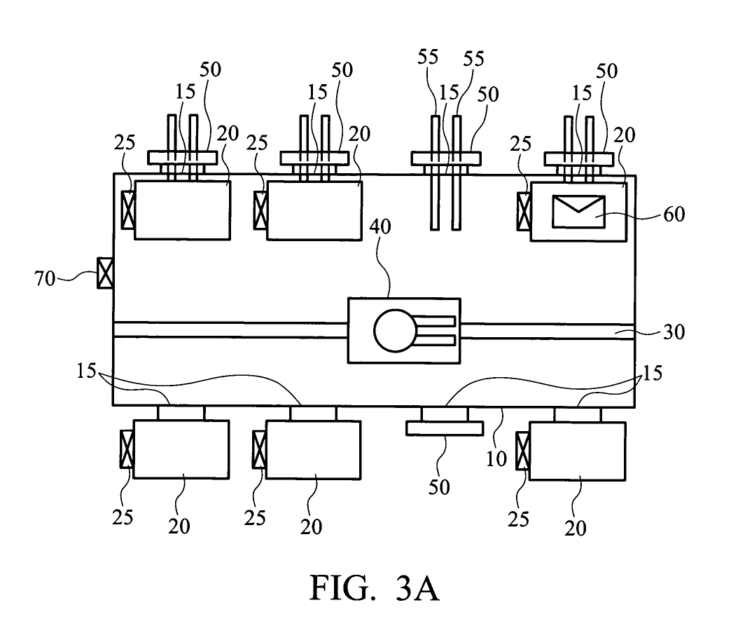

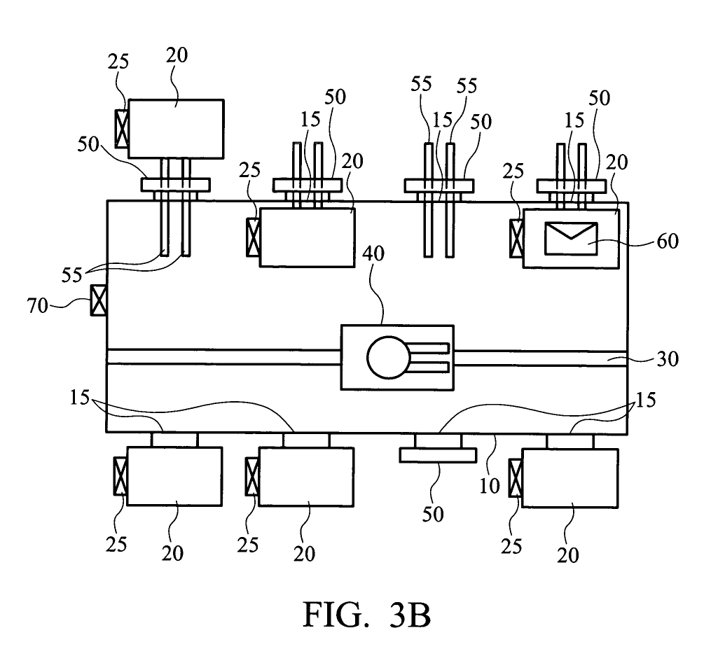

A further embodiment of the present invention of the cassette stocker is described hereinafter with reference to FIG. 3A and FIG. 3B.

In FIG. 3A and FIG. 3B, the cassette stocker comprises a housing 10, a plurality of operation devices 20, and a transferring device in the housing 10. The housing 10 has a plurality of openings 15. The transferring device comprises a rail 30 and a crane 40 on the rail 30. The present embodiment in FIG. 3A and FIG. 3B differs from the embodiment in FIG. 2 in some of the operation devices 20 are disposed in the housing 10. Further, each opening 15 has a blocking plate 50 and a moving device 55. The blocking plate 50 is disposed corresponding to the openings 15 and movably blocking the openings 15. The moving device 55 moves the operation devices 20 in the housing 10. Therefore, each operation devices 20 is moved between the outer and the inner sides of the housing 10 by the moving device 55 and the openings 15 corresponding thereto. The moving device 55, such as a track, a plurality of wheels, balls, rolling needles, or other moving devices, is capable of moving the operation device 20 in the housing 10.

When the cassette stocker is in operation as shown in FIG. 3A, the operation devices 20 are positioned in the housing 10, and the corresponding openings 15 are blocked by the blocking boards 50 to keep the housing 10 in a sealed environment. Further, when one operation device 20 is out of order, the operation device 20 can be moved outward from the housing 10 through the opening 15 to perform maintenance, and the blocking board 15 blocks the opening 15 so that the remaining operation devices 20 in the cassette stocker can be in operation instead of interruption.

It should be mentioned that the arrangement of the operation devices 20 can be determined according to the operation or space distribution in the cassette stocker. Specifically, a number of the operation devices 20 can be disposed outside of the housing 10 as the embodiment shown in FIG. 2, and a number of the operation devices 20 can be disposed in the housing as the embodiment shown in FIG. 3A and FIG. 3B.

In some embodiments, the cassette stocker can be operated with an additional transmission device or an production device. For example, the transmission device and/or the production device can be connected to the openings 15 of the housing 10, so that the cassette 60 in the operation devices 20 can be transmitted between the cassette stocker and the transmission device and/or the production device. Generally, the transmission device can be a robot, a rolling plate or other transmission device, and the production device can be a developing device such as PVD or CVD device, an etching device, a categorizing device, or other devices utilized in production.

While the invention has been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1-2. (canceled)

3. A cassette stocker, comprising:
a housing with a plurality of openings;
at least one operation device, disposed corresponding to the openings, and storing a cassette; and
a transferring device disposed in the housing, retrieving and transferring the cassette stored in the operation device via the openings,
wherein the operation device is movably disposed in the housing.

4. The cassette stocker of claim 3, further comprising:
a plurality of blocking plates, disposed corresponding to the openings, and movably blocking the openings; and
a moving device moving the operation device in the housing.

5. The cassette stocker of claim 3, wherein the transferring device comprises:
a rail; and
a crane movably disposed on the rail, moving between the openings along the rail.

6. The cassette stocker of claim 3, wherein the operation device comprises a first air cleaner.

7. The cassette stocker of claim 6, wherein the first air cleaner comprises a fan filter unit (FFU).

8. The cassette stocker of claim 3, wherein the housing comprises a second air cleaner.

9. The cassette stocker of claim 8, wherein the second air cleaner comprises a fan filter unit (FFU).

10. The cassette stocker of claim 3, wherein the operation device is a pre-stored material exchanger.

11. The cassette stocker of claim 3, wherein the openings are connected to a peripheral operation device.

12. The cassette stocker of claim 11, wherein the peripheral operation device comprises a transmission device or a production device.

13-14. (canceled)

15. A method of forming a cassette stocker, comprising:
providing a housing with a plurality of openings;
providing at least one operation device, disposed corresponding to the openings, and storing a cassette; and
providing a transferring device disposed in the housing, retrieving and transferring the cassette stored in the operation device via the openings,
wherein the operation device is movably disposed in the housing.

16. The method of forming a cassette stocker of claim 15, further comprising:
providing a plurality of blocking plates disposed corresponding to the openings and movably blocking the openings; and
providing a moving device moving the operation device in the housing.

17. The method of forming a cassette stocker of claim 15, wherein the transferring device comprises:
a rail; and
a crane movably disposed on the rail, moving between the openings along the rail.

18. The method of forming a cassette stocker of claim 15, wherein the operation device comprises a first air cleaner.

19. The method of forming a cassette stocker of claim 18, wherein the first air cleaner comprises a fan filter unit (FFU).

20. The method of forming a cassette stocker of claim 15, wherein the housing comprises a second air cleaner.

21. The method of forming a cassette stocker of claim 20, wherein the second air cleaner comprises a fan filter unit (FFU).

22. The method of forming a cassette stocker of claim 15, wherein the operation device is a pre-stored material exchanger.

23. The method of forming a cassette stocker of claim 15, wherein the openings are connected to a peripheral operation device.

24. The method of forming a cassette stocker of claim 23, wherein the peripheral operation device comprises a transmission device or a production device.
